(19) United States
(12) Patent Application Publication
(10) Pub. No.: US 2026/0093770 A1
(43) Pub. Date: Apr. 2, 2026

(54) INFORMATION PROCESSING APPARATUS, INFORMATION PROCESSING METHOD, AND STORAGE MEDIUM

(71) Applicant: NEC Corporation, Tokyo (JP)

(72) Inventor: Yuta IDEGUCHI, Tokyo (JP)

(73) Assignee: NEC Corporation, Tokyo (JP)

(21) Appl. No.: 19/335,202

(22) Filed: Sep. 22, 2025

(30) Foreign Application Priority Data
Oct. 1, 2024 (JP) 2024-172648

(51) Int. Cl. G06F 17/11; G06F 17/16

(52) U.S. Cl. CPC G06F 17/11; G06F 17/16

(57) ABSTRACT

An information processing apparatus of the present disclosure includes: a transforming unit that transforms a matrix included in a formulated model representing energy in a combinatorial optimization problem in such a manner as to decrease a rank of the matrix; a decomposing unit that decomposes the transformed matrix; and a solving unit that performs solution using the decomposed matrix.

### INCORPORATION BY REFERENCE

This application is based upon and claims the benefit of priority from Japanese patent application No. 2024-172648, filed on Oct. 1, 2024, the disclosure of which is incorporated herein in its entirety by reference.

### TECHNICAL FIELD

The present disclosure relates to an information processing apparatus, an information processing method, and a storage medium.

### BACKGROUND ART

As a method for solving real-world problems, it is common practice to transform energy in combinatorial optimization problems into the formulated Ising model format and then solve them. For example, Patent Literature 1 describes formulating energy in an optimization problem into the QUBO (Quadratic Unconstrained Binary Optimization) format and solving it by simulated annealing.
Patent Literature 1: Japanese Unexamined Patent Application Publication No. 2022-055120

However, in solving the optimization problem as described above, there arises a problem that as the problem size increases, the number of elements of a matrix included in the formulated Ising model increases and the memory capacity required for solution increases.

### SUMMARY OF THE INVENTION

Accordingly, an object of the present disclosure is to solve the abovementioned problem of an increase in memory capacity required for solving an optimization problem.

An information processing apparatus as an aspect of the present disclosure includes: a transforming unit that transforms a matrix included in a formulated model representing energy in a combinatorial optimization problem in such a manner as to decrease a rank of the matrix; a decomposing unit that decomposes the transformed matrix; and a solving unit that performs solution using the decomposed matrix.

Further, an information processing method as an aspect of the present disclosure is a method by an information processing apparatus, and the method includes transforming a matrix included in a formulated model representing energy in a combinatorial optimization problem in such a manner as to decrease a rank of the matrix; decomposing the transformed matrix; and performing solution using the decomposed matrix.

Further, a program as an aspect of the present disclosure is a program including instructions for causing an information processing apparatus to execute processes to: transform a matrix included in a formulated model representing energy in a combinatorial optimization problem in such a manner as to decrease a rank of the matrix; decompose the transformed matrix; and perform solution using the decomposed matrix.

With the configurations as described above, the present disclosure can decrease the memory capacity required for solving an optimization problem.

### BRIEF DESCRIPTION OF DRAWINGS

FIG. 1 is a block diagram showing an example of a configuration of an information processing apparatus according to the present disclosure;

FIG. 2 is a diagram showing an example of data related to the present disclosure;

FIG. 3 is a diagram showing an example of data related to the present disclosure;

FIG. 4 is a diagram showing an example of a state of processing by the information processing apparatus according to the present disclosure;

FIG. 5 is a flowchart showing an example of processing operation of the information processing apparatus according to the present disclosure;

FIG. 6 is a block diagram showing an example of a hardware configuration of an information processing apparatus according to the present disclosure; and

FIG. 7 is a block diagram showing an example of a configuration of the information processing apparatus according to the present disclosure.

### EXAMPLE EMBODIMENTS

### First Example Embodiment

A first example embodiment of the present disclosure will be described with reference to the drawings. The drawings may be related to any of the example embodiments.

An information processing apparatus 10 in the present disclosure is used to solve a preset constraint-based combinatorial optimization problem by simulated quantum annealing (simulated annealing). Here, an example of a method for solving a constraint-based combinatorial optimization problem using simulated quantum annealing will be described.

A constraint-based combinatorial optimization problem is a problem in which an objective function and a constraint condition are set and a solution that minimizes the objective function while satisfying the constraint condition is to be found. Then, a constraint-based combinatorial optimization problem can be transformed into, for example, a formulated model such as an Ising model and a QUBO (Quadratic Unconstrained Binary Optimization) model as shown by Formula 1 and Formula 2. At this time, regarding the constraint-based combinatorial optimization problem, an energy value E of the optimization problem can be expressed using objective function terms (first and second terms) and constraint condition terms (third and fourth terms) as shown by Formula 1 and can be integrated into a single model as shown by Formula 2.

$$E = {\sum }_{i} {\sum }_{j} {J}_{ij}^{′} {s}_{i} {s}_{j} + {\sum }_{i} {h}_{i}^{′} {s}_{i} + {\sum }_{i} {\sum }_{j} {\hat{J}}_{ij} {s}_{i} {s}_{j} + {\sum }_{j} {\hat{h}}_{i}^{′} {s}_{i} \qquad [ Formula 1 ]$$

$$E = {\sum }_{i} {\sum }_{j} {J}_{ij} {s}_{i} {s}_{j} + {\sum }_{i} {h}_{i} {s}_{i} = {\sum }_{i} {\sum }_{j} {W}_{ij} {s}_{i} {s}_{j} \qquad [ Formula 2 ]$$

Here, sᵢ and sⱼ in the above formulas are variables representing the states of spins sᵢ and sⱼ, and are expressed by “−1” or “1” or by “0” or “1”. In this example embodiment, a description will be made by transforming an optimization problem into a QUBO model and expressing the states of spins i and j as “0” or “1”. Note that i and j are the identification numbers of spins s. Moreover, Wᵢⱼ in Formula 2 shown above is a weight parameter set for each combination of spins sᵢ and sⱼ, and it will be referred to as a QUBO matrix below.

Then, in finding a spin that minimizes the energy E by simulated quantum annealing in the constraint-based combinatorial optimization problem described above, the state of spin s is flipped from 0 to 1 or from 1 to 0, and the solution is made to transition and searched for. At this time, in simulated quantum annealing, it always transitions when the evaluation value of a neighborhood solution is good (small) at the time of searching for the solution, but it may transition stochastically even when the evaluation value of a neighborhood solution is bad (large). At this time, the probability is determined by an inverse temperature, which is the inverse of the value of a temperature parameter, so that the information processing apparatus 10 searches for the solution while increasing or decreasing the inverse temperature. Hereinafter, an example of a configuration and operation of the information processing apparatus 10 in this example embodiment will be described in detail.

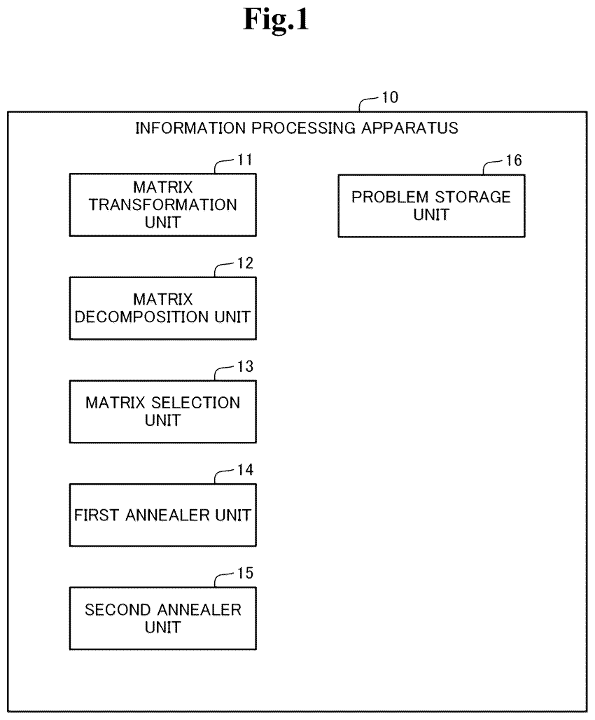

The information processing apparatus 10 is configured with one or a plurality of information processing apparatuses each including an arithmetic logic unit and a memory unit. Then, as shown in FIG. 1, the information processing apparatus 10 includes a matrix transformation unit 11, a matrix decomposition unit 12, a matrix selection unit 13, a first annealer unit 14, and a second annealer unit 15. The respective functions of the matrix transformation unit 11, the matrix decomposition unit 12, the matrix selection unit 13, the first annealer unit 14, and the second annealer unit 15 can be enabled by execution of a program for enabling the respective functions stored in the memory unit by the arithmetic logic unit. Moreover, the information processing apparatus 10 includes a problem storage unit 16 enabled with the memory unit.

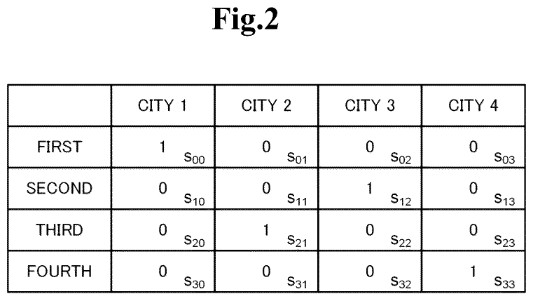

The problem storage unit 16 stores information representing a constraint-based combinatorial optimization problem to be solved. For example, in this example embodiment, a traveling salesman problem as shown in FIG. 2 will be described as an example of a constraint-based combinatorial optimization problem. A traveling salesman problem is an optimization problem to find a circuit with the smallest travel distance under a constraint that a salesman visits all cities once given the distance between the cities. The example of FIG. 2 shows a case of traveling four cities (city 1 to city 4) in order (first to fourth) and represents that there are 16 spins s (sᵢⱼ), the salesman is present when the state of spin s is “1”, and the salesman is absent when the state of spin s is “0”. Then, the energy E of the traveling salesman problem shown in FIG. 2 is shown by Formula 3.

$$E = {\sum }_{i} {\sum }_{j} {d}_{ij} {s}_{i} {s}_{j} + A {\sum }_{i = 0}^{3} {( {\sum }_{j = 0}^{3} {s}_{4 i + j} - 1 )}^{2} + A {\sum }_{i = 0}^{3} {( {\sum }_{j = 0}^{3} {s}_{4 j + i} - 1 )}^{2} \qquad [ Formula 3 ]$$

In Formula 3 shown above, the first term represents an objective function. That is to say, dᵢⱼ represents the distance between two cities, and the objective function represents the sum of the distances between two cities. Moreover, in Formula 3, the second and third terms represent constraint condition terms, which represent that a constraint is satisfied that there is only one “1” in each row and only one “1” in each column in FIG. 2.

Then, the energy value E of Formula 3 can be transformed into a QUBO model including the QUBO matrix Wᵢⱼ represented in Formula 4 shown below as described in Formulas 1 and 2 above.

$$E = {\sum }_{i} {\sum }_{j} {W}_{ij} {s}_{i} {s}_{j} \qquad [ Formula 4 ]$$

Here, as shown in Formula 5, the QUBO matrix Wᵢⱼ is composed of a weight parameter matrix W^{o}_{i,j} corresponding to the objective function in the optimization problem and a weight parameter matrix W^{c1}_{i,j} and a parameter W^{c2}_{i,j} corresponding to the constraint.

$${W}_{i , j} = {W}_{i , j}^{o} + {W}_{i , j}^{c 1} + {W}_{i , j}^{c 2} \qquad [ Formula 5 ]$$

At this time, due to the properties of the optimization problem, the same value may appear multiple times in the QUBO matrix Wᵢⱼ. For example, in the traveling salesman problem addressed in this example embodiment, the distance between cities appears multiple times in the matrix W^{o}_{i,j} corresponding to the objective function, while the same value appears multiple times in accordance with the constraints that there is only one “1” in each row and each column of the table shown in FIG. 2 in the matrices W^{c1}_{i,j} and W^{c2}_{i,j} corresponding to the constraints.

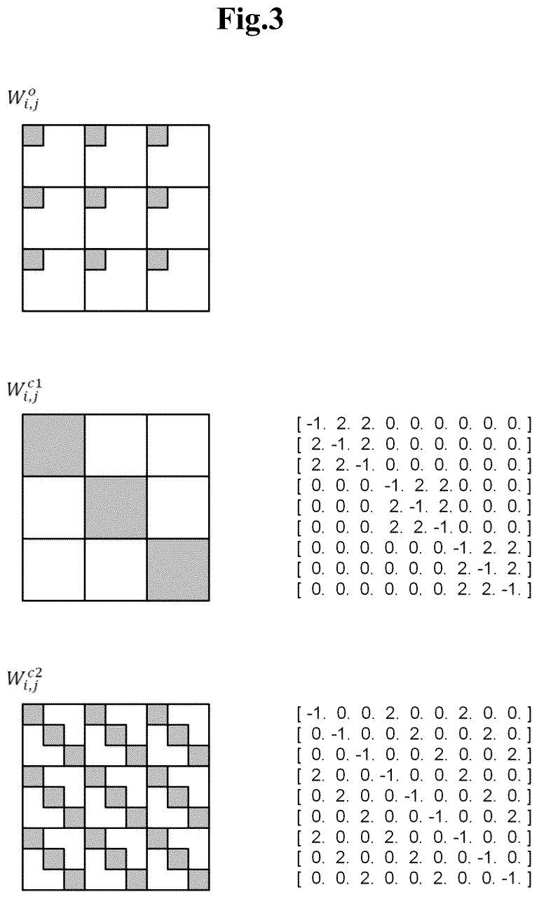

Here, FIG. 3 shows an example schematically showing the QUBO matrix Wᵢⱼ in the traveling salesman problem. In the matrix W^{o}_{i,j} corresponding to the objective function, the same value of distance corresponding to the distance between cities appears multiple times as shown in gray. Moreover, in the matrices W^{c1}_{i,j} and W^{c2}_{i,j} corresponding to the constraints, the same value repeatedly appears in accordance with the constraints that there is only one “1” in each row and each column as shown in gray. Note that an example of a concrete numerical value is shown on the right side of the matrices W^{c1}_{i,j} and W^{c2}_{i,j}. In accordance with the properties of the QUBO matrix Wᵢⱼ, the information processing apparatus 10 has the following function and is configured to perform a solution process.

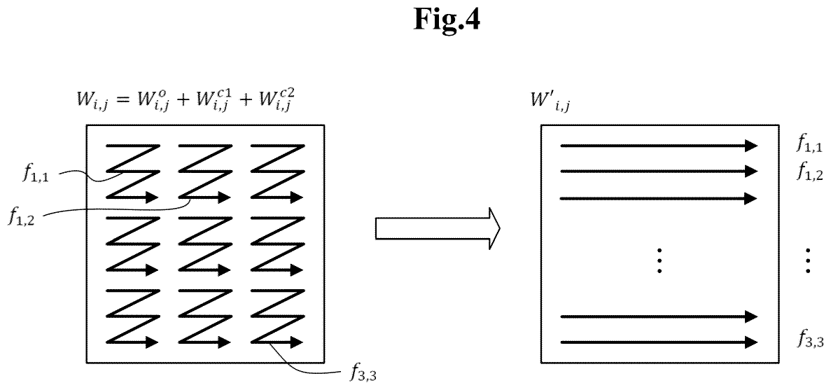

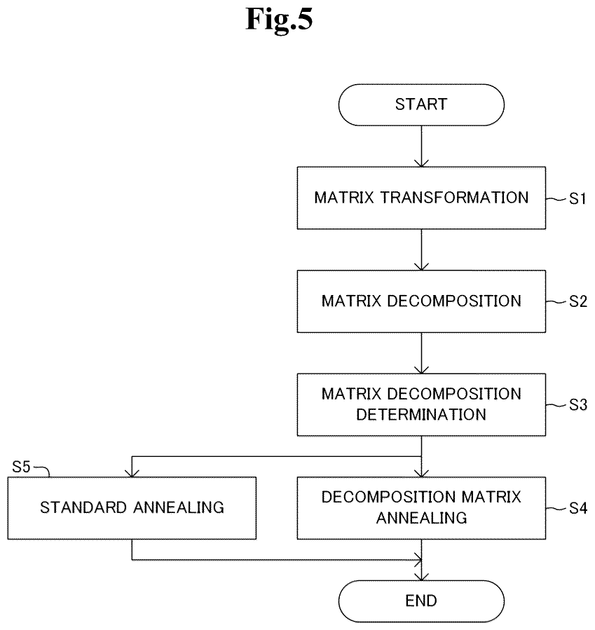

The matrix transformation unit 11 (transforming unit) transforms the QUBO matrix Wᵢⱼ to reduce the rank thereof (step S1 of FIG. 5). To be specific, the matrix transformation unit 11 transforms the QUBO matrix Wᵢⱼ into a row echelon form and transforms it so that Rank of the matrix is minimized. That is to say, the matrix transformation unit 11 performs elementary row transformation on the QUBO matrix Wᵢⱼ and calculates Rank, which is the maximum number of linearly independent row vectors. More specifically, as shown in FIG. 4, the matrix transformation unit 11 transforms elements spanning multiple rows within a predetermined range in the QUBO matrix Wᵢⱼ by arranging them in a single row, and then obtains Rank of the matrix. In the example of FIG. 4, the n×n QUBO matrix Wᵢⱼ is separated into matrices f_{1,1}, f_{1,2}, . . . and f_{3,3} of a size in a predetermined range where the number of row and column elements is smaller than n, and the matrices of the size in the predetermined range are each transformed into a single row. Thus, as depicted on the right side of FIG. 4, the QUBO matrix Wᵢⱼ is transformed into a transformation matrix W′ᵢⱼ in such a manner as to minimize Rank.

At this time, the matrix transformation unit 11 changes the size of the matrix (such as f_{1,1}) within the predetermined range in the QUBO matrix Wᵢⱼ, which is transformed into a single row, to various sizes to transform it into the transformation matrix W′ᵢⱼ. Then, the matrix transformation unit 11 repeatedly performs transformation into a single row by changing the matrix size within the predetermined range to various sizes until Rank of the transformation matrix W′ᵢⱼ is minimized. However, the matrix transformation unit 11 may transform matrices within a preset size range into a single row in the QUBO matrix Wᵢⱼ or transform matrices within a size range input from an external source into a single row to obtain Rank.

The matrix decomposition unit 12 (transforming unit) decomposes the transformation matrix W′ᵢⱼ obtained by transforming the QUBO matrix Wᵢⱼ as described above into a plurality of matrices (step S2 of FIG. 5). To be specific, the matrix decomposition unit 12 performs singular value decomposition on the transformation matrix W′ᵢⱼ to be the product of an orthogonal matrix and a diagonal matrix. As an example, the matrix decomposition unit 12 performs singular value decomposition on the transformation matrix W′ᵢⱼ as shown in Formula 6.

$${W}^{′} = {U}^{T} KV = ( \begin{matrix}{u}_{1}^{T} \\ {u}_{2}^{T} \\ ⋮ \\ {u}_{n}^{T}\end{matrix} ) ( \begin{matrix}{k}_{1 , 1} & 0 & … & 0 \\ 0 & {k}_{2 , 2} & … & 0 \\ ⋮ & ⋮ & ⋱ & ⋮ \\ 0 & 0 & … & {k}_{n , n}\end{matrix} ) ( \begin{matrix}{v}_{1} & {v}_{2} & … & {v}_{n}\end{matrix} ) \qquad [ Formula 6 ]$$

In the above Formula 6, a number other than zero in a matrix K is equal to the value of Rank of the transformation matrix W′. Therefore, the above Formula 6 can be expressed as the following Formula 7, and in the case of Rank=3 as an example, it is expressed as the following Formula 8.

$${W}^{′} = {U}^{T} KV = {U}^{T} {V}^{′} = ( \begin{matrix}{u}_{1}^{T} \\ {u}_{2}^{T} \\ ⋮ \\ {u}_{n}^{T}\end{matrix} ) ( \begin{matrix}{k}_{1 , 1} & 0 & … & 0 \\ 0 & {k}_{2 , 2} & … & 0 \\ ⋮ & ⋮ & ⋱ & ⋮ \\ 0 & 0 & … & {k}_{Rank , Rank}\end{matrix} ) ( \begin{matrix}{v}_{1} & {v}_{2} & … & {v}_{n}\end{matrix} ) \qquad [ Formula 7 ]$$

$${W}^{′} = ( \begin{matrix}{u}_{1 , 1} & {u}_{1 , 2} & {u}_{1 , 3} \\ {u}_{2 , 1} & {u}_{2 , 2} & {u}_{2 , 3} \\ ⋮ & ⋮ & ⋮ \\ {u}_{n , 1} & {u}_{n , 2} & {u}_{n , 3}\end{matrix} ) ( \begin{matrix}{k}_{1 , 1} & 0 & 0 \\ 0 & {k}_{2 , 2} & 0 \\ 0 & 0 & {k}_{3 , 3}\end{matrix} ) ( \begin{matrix}{v}_{1 , 1} & {v}_{1 , 2} & … & {v}_{1 , n} \\ {v}_{2 , 1} & {v}_{2 , 2} & … & {v}_{2 , n} \\ {v}_{3 , 1} & {v}_{3 , 2} & … & {v}_{3 , n}\end{matrix} ) = ( \begin{matrix}{u}_{1 , 1} & {u}_{1 , 2} & {u}_{1 , 3} \\ {u}_{2 , 1} & {u}_{2 , 2} & {u}_{2 , 3} \\ ⋮ & ⋮ & ⋮ \\ {u}_{n , 1} & {u}_{n , 2} & {u}_{n , 3}\end{matrix} ) ( \begin{matrix}{k}_{1 , 1} {v}_{1 , 1} & {k}_{1 , 1} {v}_{1 , 2} & … & {k}_{1 , 1} {v}_{1 , n} \\ {k}_{2 , 2} {v}_{2 , 1} & {k}_{2 , 2} {v}_{2 , 2} & … & {k}_{2 , 2} {v}_{2 , n} \\ {k}_{3 , 3} {v}_{3 , 1} & {k}_{3 , 3} {v}_{3 , 2} & … & {k}_{3 , 3} {v}_{3 , n}\end{matrix} ) \qquad [ Formula 8 ]$$

Here, in the above Formula 7, the size of a matrix U^{T} is “n×Rank”, the size of the matrix K is “Rank×Rank”, and the size of a matrix V is “Rank×n”. Then, when a matrix KV is a matrix X′, the size of the matrix V′ is “Rank×n”, and the size of the transformation matrix W′=a matrix U^{T}V′ is “n×2Rank”. That is to say, while the size of the original QUBO matrix W is “n×n”, the size of the transformation matrix W′ is “n×2Rank”, and when the value of Rank is less than or equal to half of n, the size of the transformation matrix W′ is thereby reduced. Therefore, as will be described later, when using the transformation matrix W′ instead of the QUBO matrix W in the solution process, it is possible to reduce the memory size required to store such a transformation matrix W′.

The matrix selection unit 13 (solving unit) selects whether to perform the solution process using the QUBO matrix W (annealing) or perform the solution process using the transformation matrix W′ when solving the optimization problem (step S3 in FIG. 5). Specifically, the matrix selection unit 13 selects which matrix to use for solving, according to the value of Rank of the QUBO matrix W calculated as described above.

Here, the value of Rank for solution is related to the size of the transformation matrix W′, which is “n×2Rank”, as described above. Therefore, performing the solution process using the transformation matrix W′ and accessing each element of the QUBO matrix W requires accessing memory of “n×2Rank”, resulting in an increase in number of accesses by “2Rank” times compared to solving using the QUBO matrix W with the size of “n×n”. On the other hand, as described above, when the transformation matrix W′ is smaller in size than the QUBO matrix W, the cache is more likely to be hit when solving using the transformation matrix W′ and consequently the access speed can be improved. Accordingly, the matrix selection unit 13 selects to perform the solution process using the transformation matrix W′ when determining that the access speed can improve due to cache access even in the case of accessing “2Rank” times using the transformation matrix W′, compared to accessing each element using the QUBO matrix W. On the other hand, when determining that the access speed will not improve, the matrix selection unit 13 selects to perform the solution process using the QUBO matrix W.

For example, a threshold value for Rank at which the access speed can improve due to cache access is set in advance, and the matrix selection unit 13 selects to perform the solution process using the transformation matrix W′ when Rank is less than or equal to the threshold value, and selects to perform the solution process using the QUBO matrix W when Rank is greater than the threshold value. For example, the threshold value for Rank may be set in advance based on factors such as the number of elements in the QUBO matrix W and the memory access speed, or it may be calculated and set specifically for each problem.

When selecting to perform the solution process using the transformation matrix W′, the matrix selection unit 13 inputs the transformation matrix W′ decomposed into the matrix UTV′ to the first annealer unit 14 and performs the solution process (step S4 in FIG. 5). At this time, the first annealer unit 14 calculates a position in the transformation matrix W′ of an element to be accessed within the QUBO matrix W, according to the matrix transformation method as described above, accesses the element, and performs simulated annealing. On the other hand, when selecting to perform the solution process using the QUBO matrix W, the matrix selection unit 13 inputs the QUBO matrix W into the second annealer unit 15 and performs the solution process (step S5 in FIG. 5). At this time, the second annealer unit 15 performs standard simulated annealing using the QUBO matrix W.

As described above, in the information processing apparatus 10 according to the present disclosure, the size of the matrix can be decreased by transforming and decomposing the QUBO matrix to decrease Rank in solving the optimization problem, thereby reducing the memory capacity required for the solution process. Moreover, as the size of the matrix becomes smaller, the elements of the matrix are more likely to hit the cache, and thereby an improvement in access speed can be expected.

### Second Example Embodiment

Next, a second example embodiment of the present disclosure will be described with reference to the drawings. This example embodiment shows the overview of the information processing apparatus and so forth described in the above example embodiment. Note that the drawings may be related to any of the example embodiments.

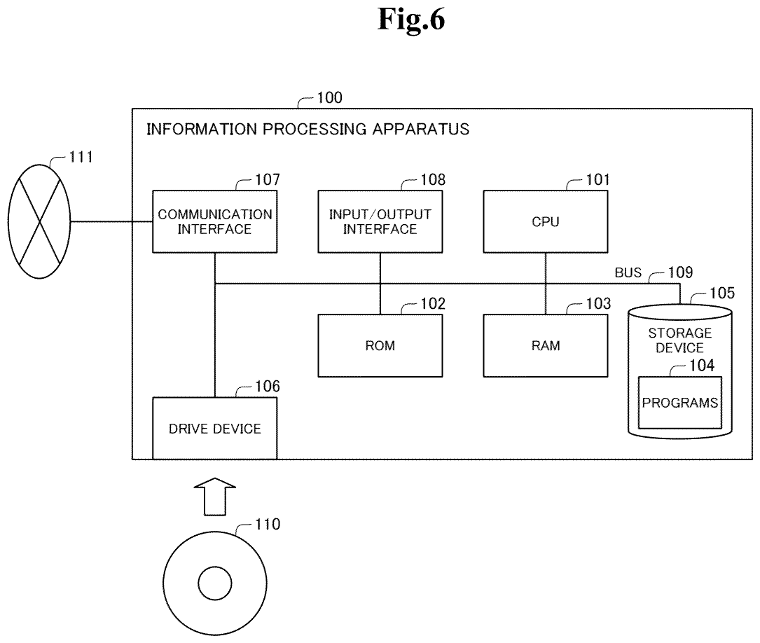

First, a hardware configuration of an information processing apparatus 100 in the present disclosure will be described. The information processing apparatus 100 is configured with a general information processing apparatus and, as an example, has the following hardware configuration as shown in FIG. 6:
a CPU (Central Processing Unit) 101 (arithmetic logic unit);
a ROM (Read Only Memory) 102 (memory unit);
a RAM (Random Access Memory) 103 (memory unit);
programs 104 loaded into the RAM 103;
a storage device 105 storing the programs 104;
a drive device 106 that performs reading from and writing into a storage medium 110 external to the information processing apparatus;
a communication interface 107 connected to a communication network 111 external to the information processing apparatus;
an input/output interface 108 that performs input/output of data; and a bus 109 connecting the components.

Note that FIG. 6 shows an example of the hardware configuration of an information processing apparatus serving as the information processing apparatus 100, and the hardware configuration of the information processing apparatus is not limited to the abovementioned case. For example, the information processing apparatus may be configured with part of the abovementioned configuration, such as not having the drive device 106. Moreover, the information processing apparatus may use a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination of these, instead of the abovementioned CPU.

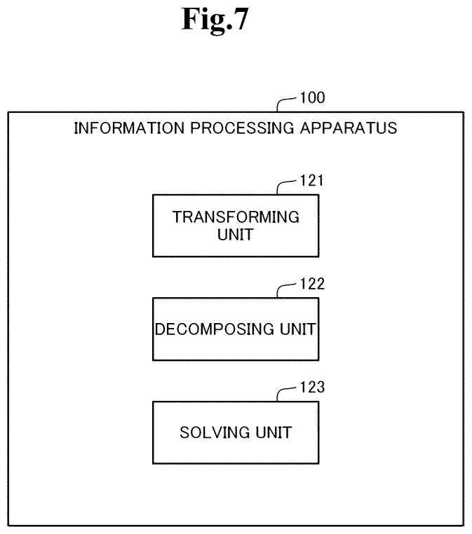

Then, by acquisition and execution of the programs 104 by the CPU 101, the information processing apparatus 100 can construct and have a transforming unit 121, a decomposing unit 121 and a solving unit 123 illustrated in FIG. 7. Note that the programs 104 are, for example, stored in advance in the storage device 105 or the ROM 102, and are loaded into the RAM 103 and executed by the CPU 101 as necessary. Moreover, the programs 104 may be provided to the CPU 101 via the communication network 111, or the programs may be stored in advance in the storage medium 110 and read out by the drive device 106 and provided to the CPU 101. However, the aforementioned transforming unit 121, decomposing unit 122, and solving unit 123 may be constructed by a dedicated electronic circuit configured to enable such means.

The transforming unit 121 transforms a matrix included in a formulated model representing energy in a combinatorial optimization problem in such a manner as to reduce the rank of the matrix. The decomposing unit 122 decomposes the transformed matrix. The solving unit 123 performs solution using the decomposed matrix.

With the configuration as described above, the present disclosure transforms and decomposes a matrix included in a model in an optimization problem in such a manner as to reduce the rank of the matrix, thereby enabling a decrease in size of the matrix, and enabling reduction of a memory capacity required for solution.

Note that at least one or more of the functions of the transforming unit 121, decomposing unit 121, and solving unit 123 described above may be executed by an information processing apparatus installed and connected at any location on a network; that is, may be executed via so-called cloud computing.

Further, the abovementioned program can be stored using various types of non-transitory computer-readable mediums and provided to a computer. The non-transitory computer-readable medium includes various types of tangible storage mediums. Examples of the non-transitory computer-readable medium include a magnetic recording medium (e.g., flexible disk, magnetic tape, hard disk drive), a magneto-optical recording medium (e.g., magneto-optical disk), a CD-ROM (Read Only Memory), a CD-R, a CD-R/W, a semiconductor memory (e.g., mask ROM, PROM (programmable ROM), EPROM (Erasable PROM), flash ROM, RAM (Random Access Memory)). Moreover, the program may be provided to a computer by various types of transitory computer-readable mediums. Examples of the temporary computer-readable mediums include electrical signals, optical signals, and electromagnetic waves. The transitory computer-readable medium can provide the program to the computer via a wired communication channel such as an electric wire and an optical fiber, or a wireless communication channel.

Although the present disclosure has been described above with reference to the example embodiments, the present disclosure is not limited to the above example embodiments. The configuration and details of the present disclosure can be changed in a variety of ways that those skilled in the art can understand within the scope of the present disclosure. Then, each of the example embodiments described above can be combined with the other example embodiment as necessary.

### <Supplementary Notes>

The whole or part of the example embodiments disclosed above can be described as the following supplementary notes. Hereinafter, the overview of the configurations of an information processing apparatus, an information processing method, and a program in the present disclosure will be described. However, the present disclosure is not limited to the configurations described in the following supplementary notes.

All or some of the configurations described in Supplementary Notes 2 to 6 dependent on Supplementary Note 1 below and the functions by such configurations may be dependent on other Supplementary Notes 7 and 10 by the same dependence as Supplementary Notes 2 to 6. Furthermore, not limited to Supplementary Notes 1, 7, and 10, within the scope of the example embodiments described above, some or all of the configurations described as supplementary notes and the functions according to such configurations may be dependent on similar hardware, software, various recording media for recording software, or systems.

### (Supplementary Note 1)

An information processing apparatus comprising:
at least one memory storing processing instructions; and
at least one processor configured to execute the processing instructions, wherein the processor is configured to execute the processing instructions to:
transform a matrix included in a formulated model representing energy in a combinatorial optimization problem in such a manner as to decrease a rank of the matrix;
decompose the transformed matrix; and perform solution using the decomposed matrix.

### (Supplementary Note 2)

The information processing apparatus according to supplementary note 1, wherein the processor is configured to execute the processing instructions to
transform by arranging elements spanning a plurality of rows within a predetermined range in the matrix into a single row.

### (Supplementary Note 3)

The information processing apparatus according to supplementary note 2, wherein the processor is configured to execute the processing instructions to
transform the matrix in such a manner as to minimize the rank of the matrix.

### (Supplementary Note 4)

The information processing apparatus according to supplementary note 1, wherein the processor is configured to execute the processing instructions to
perform singular value decomposition on the transformed matrix.

### (Supplementary Note 5)

The information processing apparatus according to supplementary note 1, wherein the processor is configured to execute the processing instructions to perform solution using either the decomposed matrix or the matrix before transformation.

### (Supplementary Note 6)

The information processing apparatus according to supplementary note 5, wherein the processor is configured to execute the processing instructions to
perform solution using either the decomposed matrix or the matrix before transformation, based on the rank of the transformed matrix.

### (Supplementary Note 7)

An information processing method by an information processing apparatus, the method comprising:
transforming a matrix included in a formulated model representing energy in a combinatorial optimization problem in such a manner as to decrease a rank of the matrix;
decomposing the transformed matrix; and
performing solution using the decomposed matrix.

### (Supplementary Note 8)

The information processing method according to supplementary note 7, comprising
transforming by arranging elements spanning a plurality of rows within a predetermined range in the matrix into a single row.

### (Supplementary Note 9)

The information processing method according to supplementary note 7, comprising
performing singular value decomposition on the transformed matrix.

### (Supplementary Note 9.1)

The information processing method according to supplementary note 7, comprising
performing solution using either the decomposed matrix or the matrix before transformation.

### (Supplementary Note 9.2)

The information processing method according to supplementary note 7, comprising
performing solution using either the decomposed matrix or the matrix before transformation, based on the rank of the transformed matrix.

### (Supplementary Note 10)

A program comprising instructions for causing an information processing apparatus to execute processes to:
transform a matrix included in a formulated model representing energy in a combinatorial optimization problem in such a manner as to decrease a rank of the matrix;
decompose the transformed matrix; and
perform solution using the decomposed matrix.

### DESCRIPTION OF REFERENCE NUMERALS

10 information processing apparatus
11 matrix transformation unit
12 matrix decomposition unit
13 matrix selection unit
14 first annealer unit
15 second annealer unit
16 problem storage unit
100 information processing apparatus
101 CPU
102 ROM
103 RAM
104 programs
105 storage device
106 drive device
107 communication interface
108 input/output interface
109 bus
110 storage medium
111 communication network
121 transforming unit
122 decomposing unit
123 solving unit

1. An information processing apparatus comprising:
at least one memory storing processing instructions; and
at least one processor configured to execute the processing instructions, wherein the processor is configured to execute the processing instructions to:
transform a matrix included in a formulated model representing energy in a combinatorial optimization problem in such a manner as to decrease a rank of the matrix;
decompose the transformed matrix; and
perform solution using the decomposed matrix.

2. The information processing apparatus according to claim 1, wherein the processor is configured to execute the processing instructions to
transform by arranging elements spanning a plurality of rows within a predetermined range in the matrix into a single row.

3. The information processing apparatus according to claim 2, wherein the processor is configured to execute the processing instructions to
transform the matrix in such a manner as to minimize the rank of the matrix.

4. The information processing apparatus according to claim 1, wherein the processor is configured to execute the processing instructions to perform singular value decomposition on the transformed matrix.

5. The information processing apparatus according to claim 1, wherein the processor is configured to execute the processing instructions to
perform solution using either the decomposed matrix or the matrix before transformation.

6. The information processing apparatus according to claim 5, wherein the processor is configured to execute the processing instructions to
perform solution using either the decomposed matrix or the matrix before transformation, based on the rank of the transformed matrix.

7. An information processing method by an information processing apparatus, the method comprising:
transforming a matrix included in a formulated model representing energy in a combinatorial optimization problem in such a manner as to decrease a rank of the matrix;
decomposing the transformed matrix; and
performing solution using the decomposed matrix.

8. The information processing method according to claim 7, comprising
transforming by arranging elements spanning a plurality of rows within a predetermined range in the matrix into a single row.

9. The information processing method according to claim 7, comprising
performing singular value decomposition on the transformed matrix.

10. The information processing method according to claim 7, comprising
performing solution using either the decomposed matrix or the matrix before transformation.

11. The information processing method according to claim 7, comprising
performing solution using either the decomposed matrix or the matrix before transformation, based on the rank of the transformed matrix.

12. A non-transitory computer-readable storage medium storing a program, the program comprising instructions for causing an information processing apparatus to execute processes to:
transform a matrix included in a formulated model representing energy in a combinatorial optimization problem in such a manner as to decrease a rank of the matrix;
decompose the transformed matrix; and
perform solution using the decomposed matrix.
